(19) United States
(12) Patent Application Publication
(10) Pub. No.: US 2009/0216620 A1
(43) Pub. Date: Aug. 27, 2009

(54) METHOD AND SYSTEM FOR PROVIDING TARGETING ADVERTISEMENT SERVICE IN SOCIAL NETWORK

(75) Inventor: Myung Jong Lee, Seongnam-si (KR)

Correspondence Address: MCCORMICK, PAULDING & HUBER LLP, CITY PLACE II, 185 ASYLUM STREET, HARTFORD, CT, 06103, US

(73) Assignee: SAMJIN LND., LTD, Hwaseong-si (KR)

(21) Appl. No.: 12/389,504

(22) Filed: Feb. 20, 2009

(30) Foreign Application Priority Data
Feb. 22, 2008 (KR) 10-2008-0016298

(51) Int. Cl. G06Q 30/00; G06Q 10/00; G06Q 99/00

(52) U.S. Cl. 705/10; 705/14; 705/1

(57) ABSTRACT

Provided is a system for providing a targeting advertisement service in a social network, the system including: a database to store information associated with a distribution of a content in the social network; an analysis unit to analyze the stored information with reference to the database, and to verify a behavioral pattern or a matter of concern of each of users in the social network based on the analysis result; and an advertisement unit to provide each of the users with a targeting advertisement, based on the verified behavioral pattern or the matter of concern.

### CROSS-REFERENCE TO RELATED APPLICATION

This application claims the benefit of Korean Patent Application No. 10-2008-0016298, filed on Feb. 22, 2008, in the Korean Intellectual Property Office, the disclosure of which is incorporated herein by reference.

### BACKGROUND

1. Field of the Invention

Embodiments of the present invention relate to a system for providing a targeting advertisement service in a social network.

2. Description of the Related Art

Generally, when people need information such as employment information, contents, and the like, or when people desire to use a service, they may ask their acquaintance, or may obtain desired information from books, newspaper, advertisements, and the like, that are provided to offer various type of information.

However, in the case of the conventional information obtaining method, it generally takes long time to procure the desired information. Also, since there is some constraint on collecting information, it may be difficult to obtain accurate information. In addition, as the Internet is becoming widespread, many people are using services for enabling them to conveniently obtain information via the Internet.

For example, a representative service may be a social network service such as Cyworld, and the like. The social network service is based on a social relationship concept in an Internet space. The social network service may support forming of a network through making a relationship between people. Specifically, the social network service may be a service that may construct a relationship network among acquaintances, for example, friends, seniors, juniors, colleagues, and the like, and may help them to manage information.

However, the conventional social network service does not provide a service that may obtain statistical information or forward information associated with a content distributed via a social network to provide users in the social network. Accordingly, the conventional social network service may not verify inclinations or matters of interests of users in the social network.

### SUMMARY

An aspect of the present invention provides a method and system for providing a targeting advertisement service in a social network that may verify a behavioral pattern or a matter of concern of each of users in a social network by analyzing a distribution type of a content in the social network, and thereby may identify an advertisement type appealing to a group of particular users and provide an advertiser with corresponding information.

Another aspect of the present invention also provides a method and system for providing a targeting advertisement service in a social network that may provide a corresponding user with an advertisement content corresponding to a behavioral pattern or a matter of concern of the user, and thereby may provide the user with a customized advertisement service.

Another aspect of the present invention also provides a method and system for providing a targeting advertisement service in a social network that may charge an advertiser an advertisement cost based on an aspect that an advertisement content is distributed in a network, for example, a number of distributions, a number of exposed users, and the like, and thereby make advertisement revenues.

The present invention is not limited to the above purposes and other purposes not described herein will be apparent to those of skill in the art from the following description.

According to an aspect of the present invention, there is provided a system for providing a targeting advertisement service in a social network, the system including: a database to store information associated with a distribution of a content in the social network; an analysis unit to analyze the stored information with reference to the database, and to verify a behavioral pattern or a matter of concern of each of users in the social network based on the analysis result; and an advertisement unit to provide each of the users with a targeting advertisement, based on the verified behavioral pattern or the matter of concern.

In this instance, the analysis unit may verify the behavioral pattern of each of the users based on an aspect where the content is forwarded by each of the user, or may verify the matter of concern of each of the users based on a property of the content that is forwarded by each of the users.

Also, the advertisement unit may provide an advertiser with the verified behavioral pattern or the matter of concern, and may receive, from the advertiser, the targeting advertisement corresponding to the behavioral pattern or the matter of concern.

Also, information associated with the distribution of the content may be information associated with a forward type between the users in the social network, and may include at least one of a forward path of the content, a number of times that the content is forwarded, a user that forwards the content more than a predetermined number of times, a time when the content is forwarded, a source of the content, and a residence area of a user that receives the content.

Also, the system may further include: a charging unit to calculate an advertisement cost of the targeting advertisement based on information associated with providing of the targeting advertisement, and to charge an advertiser associated with the targeting advertisement the calculated advertisement cost.

Also, information associated with providing of the targeting advertisement may include at least one of a number of users that forward the targeting advertisement to a second user, a number of second users that receive the targeting advertisement from the users, a number of users that receive the targeting advertisement, a number of users that are exposed to the targeting advertisement among the users that receive the targeting advertisement.

Also, the system may further include: a providing unit to provide each of the users with analysis information as the analysis result.

According to another aspect of the present invention, there is provided a system for providing a targeting advertisement service in a social network, the system including: an advertisement unit to provide each of users in the social network with a targeting advertisement corresponding to a behavioral pattern or a matter of concern of each of the users; and a charging unit to calculate an advertisement cost of the targeting advertisement based on information associated with providing of the targeting advertisement, and to charge an advertiser associated with the targeting advertisement the calculated advertisement cost.

Additional aspects, features, and/or advantages of the invention will be set forth in part in the description which follows and, in part, will be apparent from the description, or may be learned by practice of the invention.

### EFFECT OF THE INVENTION

According to embodiments of the present invention, it is possible to verify a behavioral pattern or a matter of concern of each of users in a social network by analyzing a distribution type of a content in the social network, and to thereby identify an advertisement type appealing to a group of particular users and to provide an advertiser with corresponding information.

Also, according to embodiments of the present invention, it is possible to provide a corresponding user with an advertisement content corresponding to a behavioral pattern or a matter of concern of the user, and to thereby provide the user with a customized advertisement service.

Also, according to embodiments of the present invention, it is possible to charge an advertiser an advertisement cost based on an aspect that an advertisement content is distributed in a network, for example, a number of distributions, a number of exposed users, and the like, and to thereby make advertisement revenues.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating a method of providing a targeting advertisement service in a social network according to an embodiment;

FIGS. 2 through 7 illustrate a process of collecting, storing, and providing information associated with forwarding of a content in a social network according to an embodiment of the present invention; and

FIG. 8 is a block diagram illustrating a configuration of a system for providing a targeting advertisement service in a social network according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A system for providing a targeting advertisement service in a social network according to an embodiment of the present invention may provide a user with statistical information or forward information associated with contents that are distributed via the social network. Through this, it is possible to obtain information regarding what kind of matter the user is interested in, or to enable the user to find out another user having a similar matter of concern and to thereby form a network. Also, the system for providing the targeting advertisement service in the social network may forward a customized advertisement to each of users in the social network, based on an interest thereof, and charge an advertiser based on how an advertisement provided by the advertiser is forwarded and is consumed in a network.

Hereinafter, embodiments of the present invention will be described in detail with reference to the accompanying drawings.

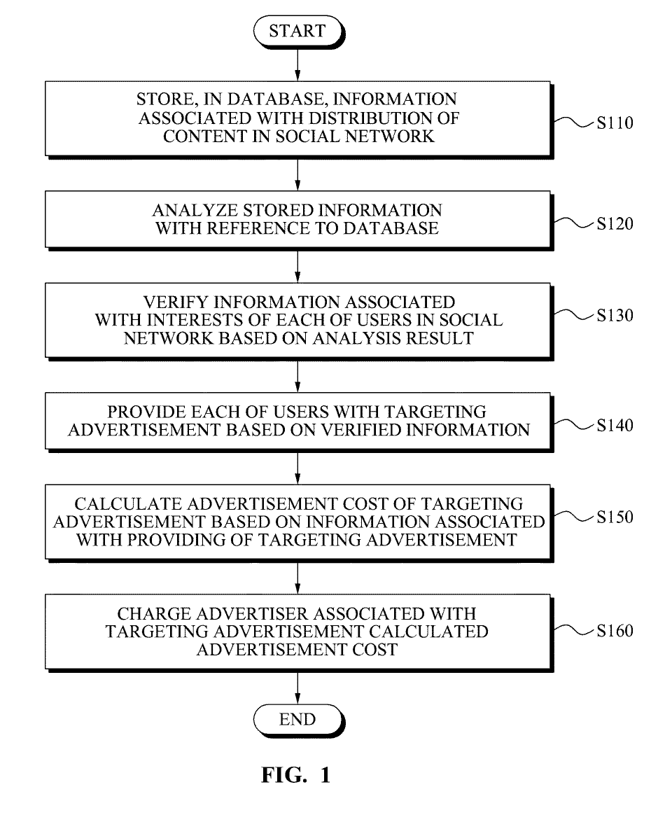

FIG. 1 is a flowchart illustrating a method of providing a targeting advertisement service in a social network according to an embodiment of the present invention. Here, the method of providing the targeting advertisement service in the social network may be performed by a system for executing the method.

Referring to FIG. 1, in operation S110, the system may store, in a database, information associated with a distribution of a content in the social network. Here, information associated with the distribution of the content may be information associated with a forward type between the users in the social network, and may include at least one of a forward path of the content, a number of times that the content is forwarded, a user that forwards the content more than a predetermined number of times, that is, a user that actively forwards the content, a time when the content is forwarded, a source of the content, and a residence area of a user that receives the content.

In operation S120, the system may analyze the stored information with reference to the database. In operation S130, the system may verify information associated with interests of each of users in the social network, based on the analysis result. In this instance, information associated with the interests may include a behavioral pattern, a matter of concern, and the like of each of the users.

Specifically, the system may analyze information associated with the distribution of the content that is stored in the database, and thereby may initially verify an aspect that the content is forwarded by each of the users and may subsequently verify the behavioral pattern of each of the users based on the forward aspect of the content. Accordingly, the system may identify a user that may most distantly spread the content, a user that may most spread the content, a user that may provide a content desired by many users, and the like.

Also, the system may analyze information associated with the distribution of the content that is stored in the database, and thereby may initially verify a property of the content that a corresponding user forwards, and may subsequently verify a matter of concern of the user based on the verified property. Accordingly, the system may accurately identify an advertisement type appealing to a group of particular users, by referring to the user's verified matter of concern.

The system may provide each of the users with the analysis result, that is, analysis information. Specifically, the system may provide the analysis information for a corresponding user associated with the distribution of the content.

In operation S140, the system may provide each of the users with a targeting advertisement, based on the verified information, for example, the behavioral pattern or the matter of concern. Specifically, the system may classify each of the users according to the verified behavioral pattern or the matter of concern, and provide each of the classified users with a corresponding targeting advertisement. For this, the system may provide an advertiser with information associated with the verified behavioral pattern or the matter of concern. In response thereto, the system may receive, from the advertiser, a targeting advertisement corresponding to the behavioral pattern or the matter of concern.

For example, the system may classify each of the users in the social network according to the behavioral pattern, the matter of concern, and the like, as follows.

Initially, in the case of a classification according to the behavioral pattern, the system may classify the users into an initiator type that retrieves a new content and then informs his/her acquaintances about the retrieved new content, a hub type that does not retrieve the new content but forwards the content to relatively many users in the social network, a consumer type that receives and consumes the content, and the like.

In the case of a classification according to the matter of concern, the system may classify the users based on which category a corresponding user is interested in, what the recent matter of concern is, whether there is a possibility that users may be interested in both a subject A and a subject B, and the like.

In operation S150, the system may calculate an advertisement cost of the targeting advertisement based on information associated with providing of the targeting advertisement.

Specifically, the system may calculate the advertisement cost of the targeting advertisement, based on a number of users that forward the targeting advertisement to a second user, and a number of second users that receive the targeting advertisement from the user. For example, when the targeting advertisement is forwarded to an appropriate user and the user receiving the targeting advertisement forwards to the user's acquaintances, the system may calculate a cost per user forwarding the targeting advertisement and a cost per user receiving the targeting advertisement, and add up the calculated costs, and then calculate the result value as the advertisement cost of the targeting advertisement.

Also, the system may calculate the advertisement cost of the targeting advertisement based on the number of users that receive the targeting advertisement. For example, the system may calculate a cost per user, based on the number of users that forward the targeting advertisement, and calculate the result value as the advertisement cost of the targeting advertisement.

Also, the system may calculate the advertisement cost of the targeting advertisement based on a number of users that are exposed to the targeting advertisement among the users that receive the targeting advertisement. For example, the system may calculate a cost per user based on a number of users that view the targeting advertisement, and calculate the result value as the advertisement cost of the targeting advertisement.

Also, the system may calculate a predetermined amount of money as the advertisement cost of the targeting advertisement. Specifically, the system may charge an advertiser the predetermined amount of money as the advertisement cost and thereby prevent the advertisement cost from being excessively calculated, which results in causing a damage to the advertiser. For example, even when a number of times that an advertisement is forwarded abnormally increases due to a malicious intent of a user, it is possible to prevent the advertisement cost from being excessively calculated.

In operation S160, the system may charge an advertiser associated with the targeting advertisement the calculated advertisement cost.

As described above, according to an embodiment of the present invention, a method of providing a targeting advertisement service in a social network may analyze a distribution type of a content in the social network and verify an inclination of each of users and thereby may identify an advertisement type appealing to a group of particular users and provide an advertiser with corresponding information.

Also, according to an embodiment of the present invention, a method of providing a targeting advertisement service in a social network may provide a corresponding user with an advertisement content corresponding to an inclination of the user and thereby provide the user with a customized advertisement service.

Also, according to an embodiment of the present invention, a method of providing a targeting advertisement service in a social network may charge an advertiser based on an aspect that an advertisement content is distributed in a network, for example, a number of times that the advertisement content is forwarded, a number of users that are exposed to the advertisement content, and the like, and thereby make advertisement revenues.

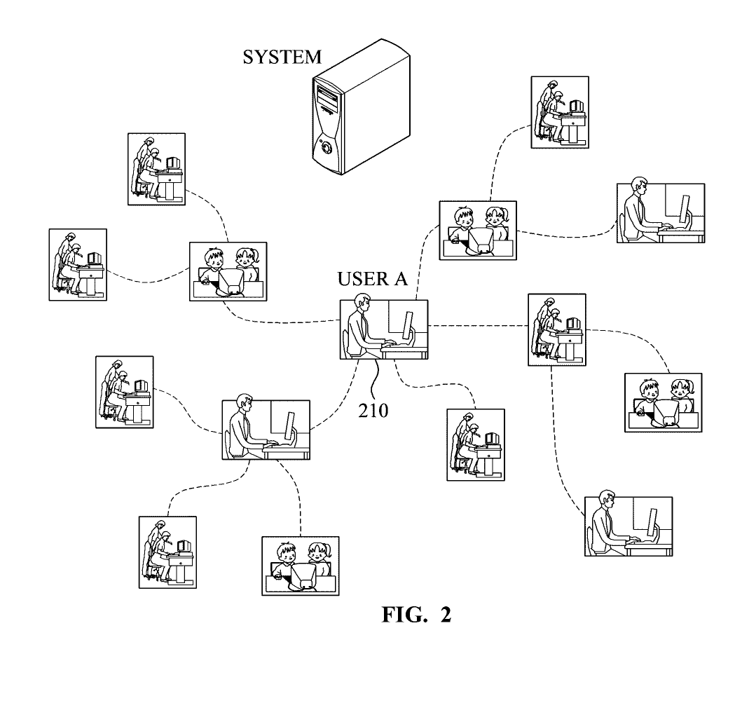

FIGS. 2 through 7 illustrate a process of collecting, storing, and providing information associated with forwarding of a content in a social network according to an embodiment of the present invention.

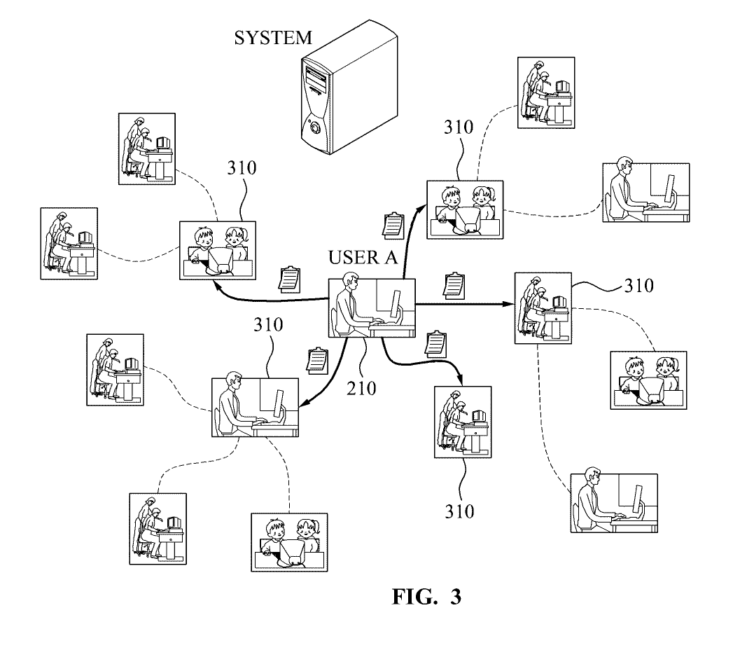

Here, it is assumed that a social network is constructed as shown in FIG. 2, and a user A 210 is connected to other users, for example, his acquaintances or friends via a network. In this case, as shown in FIG. 3, the user A 210 may find an interesting content and transmit the found content to other users 310 in the network.

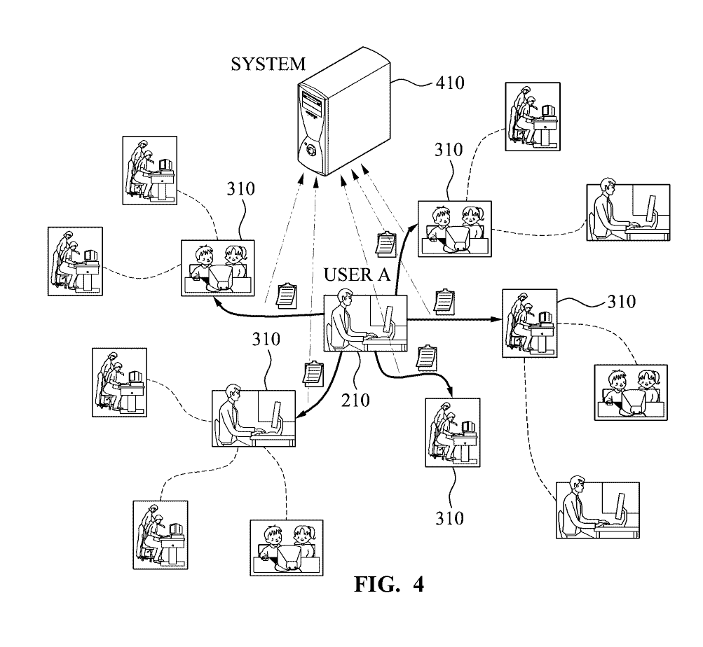

As shown in FIG. 4, when the user A 210 transmits the content to the other users 310, a system 410 may collect information regarding that the content is transmitted to the other users 310, and may store the collected information in a database.

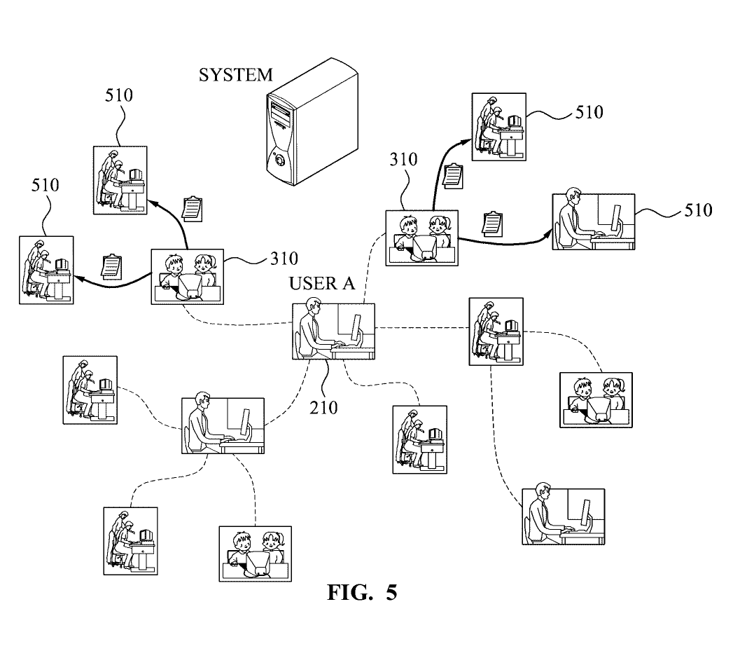

As shown in FIG. 5, when some of the other users 310 receiving the content from the user A 210 view the content desire to share the content due to their interests in the content, they may forward the content to still other users 510, for example, their own acquaintances or friends.

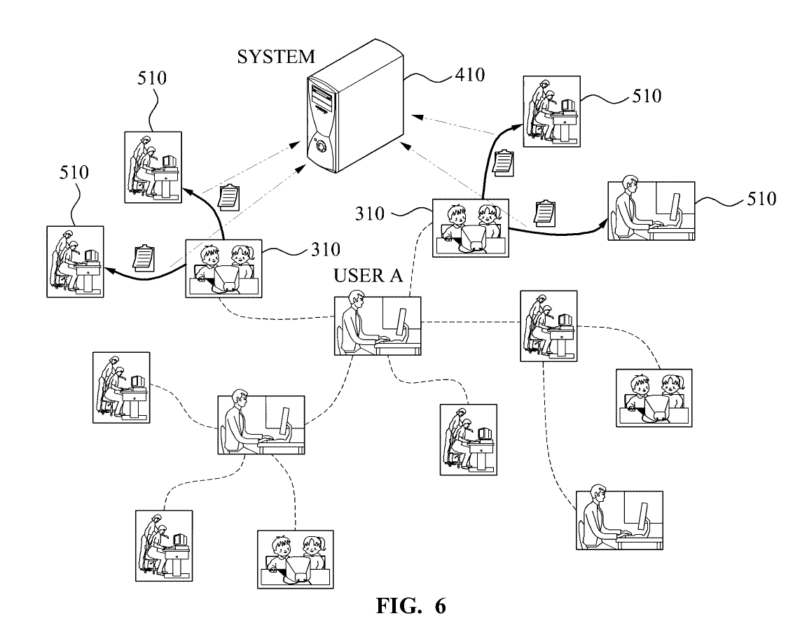

As shown in FIG. 6, the system 410 may collect information regarding that the other users 310 forward the content to still another users 510, and store the collected information in the database.

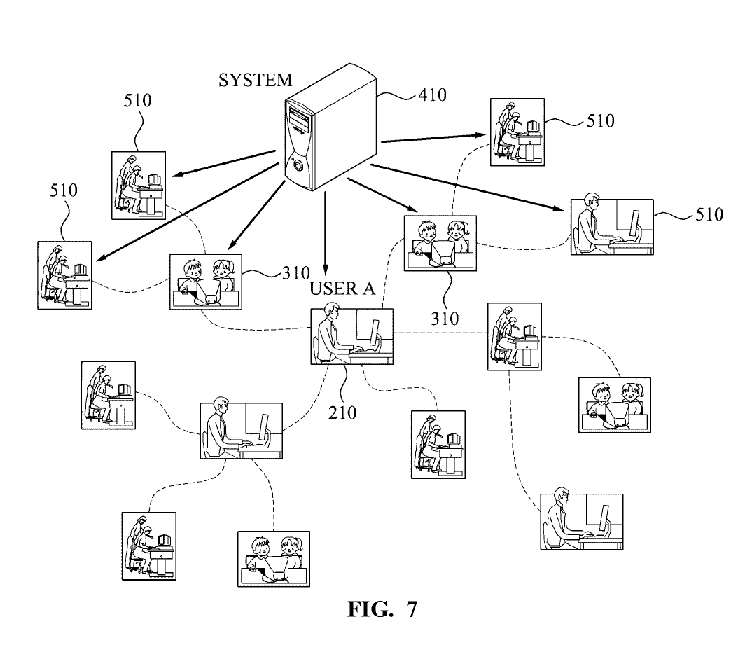

As shown in FIG. 7, the system 410 may process the stored information, that is, information associated with forwarding of the content, and transmit the processed information to the related users 210, 310, and 510.

For example, the system 410 may inform the users 210, 310, and 510 about statistical information regarding to how many people the user A 210 forwarded the content to at which level and a location where they receiving the content live. Also, the system 410 may inform the users 210, 310, and 510 about information regarding which user has most widely distributed the content among the users 210, 310, and 510, and which user most quickly responded to the content.

Also, the system 410 may information the users 210, 310, and 510 about additional information regarding how the content is forwarded to a corresponding user, in which area the content is generally distributed among users, how long it takes to forward the content, and the like.

As described above, since information associated with forwarding of a content is collected and is stored in the database, and the stored information is provided for users, a corresponding user may be aware of an inclination, a matter of concern, etc., of the user's acquaintances.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

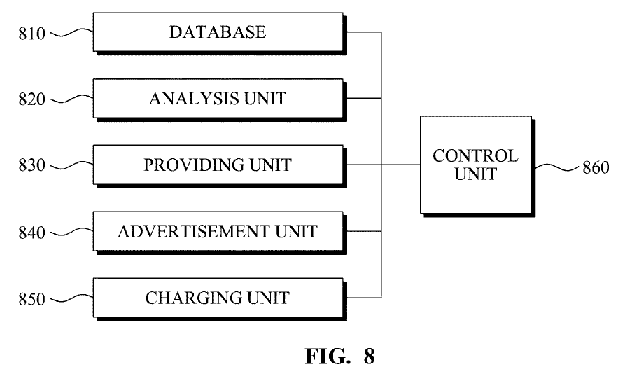

FIG. 8 is a block diagram illustrating a configuration of a system for providing a targeting advertisement service in a social network according to an embodiment of the present invention.

Referring to FIG. 8, the system may include a database 810, an analysis unit 820, a providing unit 830, an advertisement unit 840, a charging unit 850, and a control unit 860.

The database 810 may store information associated with a distribution of a content in the social network. Here, information associated with the distribution of the content may be information associated with a forward type between the users in the social network, and may include at least one of a forward path of the content, a number of times that the content is forwarded, a user that forwards the content more than a predetermined number of times, that is, a user that actively forwards the content, a time when the content is forwarded, a source of the content, and a residence area of a user that receives the content.

The analysis unit 820 may analyze the stored information with reference to the database 810. Also, the analysis unit 820 may verify information associated with interests of each of users in the social network, based on the analysis result. In this instance, information associated with the interests may include a behavioral pattern, a matter of concern, and the like of each of the users.

Specifically, the analysis unit 820 may analyze information associated with the distribution of the content that is stored in the database 810, and thereby may initially verify an aspect that the content is forwarded by each of the users and may subsequently verify the behavioral pattern of each of the users based on the forward aspect of the content. Accordingly, the analysis unit 820 may identify a user that may most distantly spread the content, a user that may most spread the content, a user that may provide a content desired by many users, and the like.

Also, the analysis unit 820 may analyze information associated with the distribution of the content that is stored in the database 810, and thereby may initially verify a property of the content that a corresponding user forwards, and may subsequently verify a matter of concern of the user based on the verified property. Accordingly, the analysis unit 820 may accurately identify an advertisement type appealing to a group of particular users, by referring to the user's verified matter of concern.

The providing unit 830 may provide each of the users with the analysis result, that is, analysis information. Specifically, the providing unit 830 may provide the analysis information for a corresponding user associated with the distribution of the content. Also, the providing unit 830 may provide the analysis information for another user associated with the distribution of the content.

The advertisement unit 840 may provide each of the users with a targeting advertisement, based on the verified information, for example, the behavioral pattern or the matter of concern. Specifically, the advertisement unit 840 may classify each of the users according to the verified behavioral pattern or the matter of concern, and provide each of the classified users with a corresponding targeting advertisement. For this, the advertisement unit 840 may provide an advertiser with information associated with the verified behavioral pattern or the matter of concern. In response thereto, the advertisement unit 840 may receive, from the advertiser, a targeting advertisement corresponding to the behavioral pattern or the matter of concern.

The charging unit 850 may calculate an advertisement cost of the targeting advertisement based on information associated with providing of the targeting advertisement. The charging unit 850 may charge an advertiser associated with the targeting advertisement the calculated advertisement cost.

Specifically, the charging unit 850 may calculate the advertisement cost of the targeting advertisement, based on a number of users that forward the targeting advertisement to a second user, and a number of second users that receive the targeting advertisement from the user, and then may charge the advertiser of the targeting advertisement the calculated advertisement cost For example, when the targeting advertisement is forwarded to an appropriate user and the user receiving the targeting advertisement forwards to the user's acquaintances, the charging unit 850 may calculate a cost per user forwarding the targeting advertisement and a cost per user receiving the targeting advertisement, and add up the calculated costs, and then calculate the result value as the advertisement cost of the targeting advertisement. The charging unit 850 may charge the advertiser of the targeting advertisement the calculated result value as the advertisement cost

Also, the charging unit 850 may calculate the advertisement cost of the targeting advertisement based on the number of users that receive the targeting advertisement, and then may charge the advertiser of the targeting advertisement the calculated advertisement cost. For example, the charging unit 850 may calculate a cost per user, based on the number of users that forward the targeting advertisement, and calculate the result value as the advertisement cost of the targeting advertisement. The charging unit 850 may charge the advertiser of the targeting advertisement the calculated advertisement cost.

Also, the charging unit 850 may calculate the advertisement cost of the targeting advertisement based on a number of users that are exposed to the targeting advertisement among the users that receive the targeting advertisement, and then may charge the advertiser of the targeting advertisement the calculated advertisement cost. For example, the charging unit 850 may calculate a cost per user based on a number of users that view the targeting advertisement, and calculate the result value as the advertisement cost of the targeting advertisement. The charging unit 850 may charge the advertiser of the targeting advertisement the calculated advertisement cost.

Also, the charging unit 850 may calculate a predetermined amount of money as the advertisement cost of the targeting advertisement, and may charge the advertiser of the targeting advertisement the predetermined amount of money.

As described above, according to an embodiment of the present invention, a system for providing a targeting advertisement service in a social network may analyze a distribution type of a content in the social network and verify an inclination of each of users and thereby may identify an advertisement type appealing to a group of particular users and provide an advertiser with corresponding information.

Also, according to an embodiment of the present invention, a system for providing a targeting advertisement service in a social network may provide a corresponding user with an advertisement content corresponding to an inclination of the user and thereby provide the user with a customized advertisement service.

Also, according to an embodiment of the present invention, a system for providing a targeting advertisement service in a social network may charge an advertiser based on an aspect that an advertisement content is distributed in a network, for example, a number of times that the advertisement content is forwarded, a number of users that are exposed to the advertisement content, and the like, and thereby make advertisement revenues.

Although a target for embodying the invention is described as a personal computer (PC) for ease of comprehension, it will be apparent to those skilled in the art that the present invention is not limited thereto. Specifically, the present invention may be embodied in all the media that is directly or indirectly accessible to the Internet, such as a mobile terminal, a wired terminal, and the like.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for providing a targeting advertisement service in a social network, the system comprising:
a database to store information associated with a distribution of a content in the social network;
an analysis unit to analyze the stored information with reference to the database, and to verify a behavioral pattern or a matter of concern of each of users in the social network based on the analysis result; and
an advertisement unit to provide each of the users with a targeting advertisement, based on the verified behavioral pattern or the matter of concern.

2. The system of claim 1, wherein the analysis unit verifies the behavioral pattern of each of the users based on an aspect where the content is forwarded by each of the user, or verifies the matter of concern of each of the users based on a property of the content that is forwarded by each of the users.

3. The system of claim 1, wherein the advertisement unit provides an advertiser with the verified behavioral pattern or the matter of concern, and receives, from the advertiser, the targeting advertisement corresponding to the behavioral pattern or the matter of concern.

4. The system of claim 1, wherein information associated with the distribution of the content is information associated with a forward type between the users in the social network, and comprises at least one of a forward path of the content, a number of times that the content is forwarded, a user that forwards the content more than a predetermined number of times, a time when the content is forwarded, a source of the content, and a residence area of a user that receives the content.

5. The system of claim 1, further comprising:
a charging unit to calculate an advertisement cost of the targeting advertisement based on information associated with providing of the targeting advertisement, and to charge an advertiser associated with the targeting advertisement the calculated advertisement cost.

6. The system of claim 5, wherein information associated with providing of the targeting advertisement comprises at least one of a number of users that forward the targeting advertisement to a second user, a number of second users that receive the targeting advertisement from the users, a number of users that receive the targeting advertisement, a number of users that are exposed to the targeting advertisement among the users that receive the targeting advertisement.

7. The system of claim 1, further comprising:
a providing unit to provide each of the users with analysis information as the analysis result.

8. A system for providing a targeting advertisement service in a social network, the system comprising:
an advertisement unit to provide each of users in the social network with a targeting advertisement corresponding to a behavioral pattern or a matter of concern of each of the users; and
a charging unit to calculate an advertisement cost of the targeting advertisement based on information associated with providing of the targeting advertisement, and to charge an advertiser associated with the targeting advertisement the calculated advertisement cost.
